(19) United States
(12) Patent Application Publication
(10) Pub. No.: US 2023/0357904 A1
(43) Pub. Date: Nov. 9, 2023

(54) REINFORCED ALLOY FOR BRACKET

(71) Applicant: MATERION CORPORATION, Mayfield Heights, OH (US)

(72) Inventors: Andreas Frehn, Alzenau (DE); Andrew Tarrant, Hampshire (GB)

(73) Assignee: MATERION CORPORATION, Mayfield Heights, OH (US)

(21) Appl. No.: 18/312,964

(22) Filed: May 5, 2023

Related U.S. Application Data
(60) Provisional application No. 63/339,126, filed on May 6, 2022.

(51) Int. Cl. C22C 32/00; C22C 21/16; E05B 71/00

(52) U.S. Cl. CPC C22C 32/0063; C22C 21/16; E05B 71/00

(57) ABSTRACT

A reinforced alloy comprising reinforcement particles (fine and/or coarse) for a bracket that provides enhanced theft deterrence and lightweight. The bracket may be used for a lock for a personal transportation vehicle.

### CROSS-REFERENCE TO RELATED APPLICATIONS

This application claims priority to U.S. Provisional Application No. 63/339,126, filed May 6, 2022, which is fully incorporated by reference herein.

### TECHNICAL FIELD

The present disclosure relates to reinforced alloys that possess excellent cut resistance while being lightweight and durable for use as a bracket, in particular for a bracket that is suitable lock for a vehicle. In particular, the reinforced alloys may comprise a composite including aluminum or an aluminum alloy and fine particles dispersed therein, and coarse reinforcement particles.

### BACKGROUND

Bicycle use for transportation and recreation has become increasingly popular, particularly as people search for more environmentally friendly ways to travel. However, bicycles, like many other personal transportation vehicles—scooters, mopeds, etc.—suffer from problems with securing when not in use. These vehicles are left unattended in public areas and cannot be self-secured against theft and thus are vulnerable when left all day or overnight. In particular, bicycles are increasingly popular with users seeking healthy living and reduced environmental impact. As the popularity increases users are drawn to more expensive vehicles. Self-propelled bicycles do not consume energy, hence the market is growing fast. Companies also deploy personal transportation vehicles thorough cities for daily use and must secure the vehicles when not in use. However securing such vehicles when not in use is one of the most important concerns when purchasing. Thus a separable lock is needed for the users of such personal transportation vehicles.

There are four types of the conventional locks for personal transportation vehicles. U-shaped locks or cable locks can be attached to the vehicle frame when riding and locked to a fixed object by extending a part of the lock through the wheels and/or frame. However, these locks are difficult to secure to the frame and can easily hit the frame or scrape its coating off. To overcome this problem, a fixed lock may be used. A fixed lock is usually located on the seat stays located above the rear wheel. A latch can be extended through the rear wheel to prevent the rear wheel from rotating, and can be unlocked with a key. However, each of these locks are easily accessed by the thieves and are easily cut using a tool. Thus, a third type of lock may be used. This third type of lock is located within the front fork and restricts the rotation of the handlebar to secure the bicycle. The fourth type is located within the seat tube and restricts rotation of the crank. However, neither of these locks may be transferred from one vehicle to another, and usually increase the manufacturing cost of the vehicle.

Most importantly, each of the locks described above are vulnerable to thieves due to the ease of cutting the iron alloys and carbon-steel alloys from which are made.

Another issue with locks is that the user must carry the lock, thereby increasing the weight carried while riding. Currently, manufacturers are limited in reducing the weight of the lock without sacrificing anti-theft deterrence. One common method to increase theft deterrence is to increase the diameter of the lock in order to increase its strength. However, the increased diameter results in increased weight. Furthermore, increasing the size of the lock makes it more bulky and cumbersome to transport. Increased amounts of material in the lock may increase the price of the lock.

Aside from picking the locking mechanism, a thief with the right tools can break or otherwise defeat most locks used for personal transportation vehicles in a few minutes. As local police devote little time and attention to theft of personal transportation vehicles, particularly bicycles, the user must assume the burden of protecting their vehicle by making the best possible choice for a lock.

Accordingly there continues to be a need for improvements to locks that provide enhance anti-theft protection while being lightweight and easily transportable.

### BRIEF DESCRIPTION

In one aspect, there is provided a lock for a vehicle, such as but not limited to a bicycle, motorcycle, moped or scooter. Accordingly, to deter theft, there is provided a lock for a vehicle having an opening, the lock comprising: a bracket capable of fitting through the opening, and a crossbar to removable secure at least a portion of the bracket thereby lock the vehicle to an object. The bracket comprises a reinforced alloy comprising a composite comprising an aluminum or aluminum alloy and first (fine) reinforcement particles dispersed in the aluminum or aluminum alloy, the first reinforcement particles having an average particle size (D50) of from 0.1 μm to 5.0 μm; and second (coarse) reinforcement particles having an average particle size (D50) being greater than or equal to 20 μm, e.g., from 20 μm to 200 μm. The bracket may have a U-shape with two substantially parallel legs, each of the legs having a solid cross section. In one embodiment, the aluminum alloy comprises aluminum; and at least one alloying element selected from the group consisting of chromium, copper, lithium, magnesium, manganese, zinc, iron, nickel, silver, scandium, vanadium, titanium, and silicon. In one embodiment, the first reinforcement particles are selected from the group comprising silicon carbide, silicon nitride, silicon dioxide, titanium carbide, titanium nitride, titanium boride, boron carbide, aluminum oxide, and zirconium oxide. Preferably, the first reinforcement particles are silicon carbide. The first reinforcement particles may have an average particle size (D50) of from 0.7 μm to 3.0 μm. In one embodiment, the second reinforcement particles are selected from the group comprising silicon carbide, silicon nitride, silicon dioxide, titanium carbide, titanium nitride, titanium boride, boron carbide, aluminum oxide, and zirconium oxide. Preferably, the second reinforcement particles are silicon carbide. The second reinforcement may be at least 5×larger than the first reinforcement particles. In one embodiment, the composite comprises the aluminum or aluminum alloy in an amount from 60 wt. % to 95 wt. %, the reinforced alloy comprises the first reinforcement particles in an amount from 5 wt. % to 40 wt. %, based on the weight of the composite. The reinforced alloy comprises the composite and the second reinforcement particles in an amount from 1 wt. % to 10 wt. %, based on the weight of the reinforced alloy.

In one aspect, there is provided a lock for a vehicle having an opening, the lock comprising: a bracket capable of fitting through the opening, and a crossbar to removable secure at least a portion of the bracket thereby lock the vehicle to an object. The bracket comprises a reinforced alloy comprising a composite comprising an aluminum alloy, first (fine) reinforcement particles dispersed in the aluminum or aluminum alloy and second (coarse) reinforcement particles being larger than the first (fine) reinforcement particles. The aluminum alloy may comprise from 70 wt. % to 99.9 wt. % of aluminum, from 0 to 10 wt. % chromium, from 0 to 10 wt. % copper, from 0 to 3 wt. % lithium, from 0 to 5 wt. % magnesium, from 0 to 3 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 3 wt. % iron, and/or from 0 to 25 wt. % silicon. In one embodiment, the first reinforcement particles having an average particle size (D50) of from 0.1 μm to 5.0 μm, e.g., from 0.7 μm to 3.0 μm. and second (coarse) reinforcement particles having an average particle size (D50) being greater than or equal to 20 μm, e.g., from 20 μm to 200 μm. In one embodiment, the first reinforcement particles are selected from the group comprising silicon carbide, silicon nitride, silicon dioxide, titanium carbide, titanium nitride, titanium boride, boron carbide, aluminum oxide, and zirconium oxide. Preferably, the first reinforcement particles are silicon carbide. In one embodiment, the second reinforcement particles are selected from the group comprising silicon carbide, silicon nitride, silicon dioxide, titanium carbide, titanium nitride, titanium boride, boron carbide, aluminum oxide, and zirconium oxide. Preferably, the second reinforcement particles are silicon carbide. The second reinforcement may be at least 5×larger than the first reinforcement particles. In one embodiment, the composite comprises the aluminum or aluminum alloy in an amount from 60 wt. % to 95 wt. %, the first reinforcement particles in an amount from 5 wt. % to 40 wt. %, based on the weight of the composite. The reinforced alloy comprises the composite and the second reinforcement particles in an amount from 1 wt. % to 10 wt. %, based on the weight of the reinforced alloy. The bracket may have a U-shape with two substantially parallel legs, each of the legs having a solid cross section.

In another aspect, there is provided a lock for a vehicle having an opening, the lock comprising: a bracket capable of fitting through the opening, and a crossbar to removable secure at least a portion of the bracket thereby lock the vehicle to an object and wherein the bracket is formed from a reinforced alloy comprising a composite comprising an aluminum or aluminum alloy and first (fine) reinforcement particles dispersed in the aluminum or aluminum alloy, the first reinforcement particles having an average particle size (D50) of from 0.1 μm to 5.0 μm. In one embodiment, the bracket does not contain coarse (second) reinforcement particles. In one embodiment, the first reinforcement particles are selected from the group comprising silicon carbide, silicon nitride, silicon dioxide, titanium carbide, titanium nitride, titanium boride, boron carbide, aluminum oxide, and zirconium oxide. Preferably, the first reinforcement particles are silicon carbide. In one embodiment, the composite comprises the aluminum or aluminum alloy in an amount from 60 wt. % to 95 wt. %, and the first reinforcement particles in an amount from 5 wt. % to 40 wt. %, based on the weight of the composite. The bracket may have a U-shape with two substantially parallel legs, each of the legs having a solid cross section.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 shows the results of a handsaw cutting test, as described in the Example.

FIG. 2 shows the results of an angle grinder cutting test, as described in the Example.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The present disclosure provides a bracket for lock for a personal transportation vehicle, such as a bicycle, motorcycle, moped, scooter, for example. Securing these types of personal transportation vehicles is improved by using a bracket as described herein. The vehicle may have an opening in the frame and/or wheel through which the bracket may be inserted and secured to an object to deter theft. The bracket may be secured to a locking mechanism. The bracket has a rigid construction with limited flexibility. In one embodiment, the bracket is primarily constructed of a reinforced alloy as described herein.

Although the bracket may be used with several different types of locks, users have found U-locks to be particular suitable for securing personal transportation vehicles. Accordingly, unless indicated otherwise, the present disclosure is generally described in terms of U-lock it should be understood to those skilled in the art that the bracket may be used with several different types of locks. In one embodiment, the U-lock comprises a U-shaped bracket, a crossbar, and a locking mechanism. The U-shaped bracket may be a shackle having legs or fittings with configured feet. The feet may be configured to fit into holes in a crossbar that has corresponding openings to receive the feet. The crossbar may include a locking mechanism to retain or release the feet. As commonly constructed the U-shaped bracket is constructed of continuous or solid material. In one embodiment, the U-shaped bracket is primarily constructed of a reinforced alloy as described herein. The U-shaped bracket has a curved portion, i.e. circular curve, oval curve, or parabolic curve, etc., opposite of the crossbar when secured by the locking mechanism. The legs of the U-shaped bracket are generally perpendicular to the crossbar when secured by the locking mechanism. The length of the leg may vary and are generally from 10 cm to 60 cm, e.g., from 10 cm to 30 cm. In one embodiment, the bracket may be a combination of a rectangle shape for the legs and oval for the U-shaped portion.

In one embodiment, the U-shaped bracket comprises at least two substantially parallel legs. In one embodiment the cross-sectional diameter is circular in shape or oval in shape. The cross-sectional diameter of the legs may be from 5 mm to 30 mm, e.g., from 10 to 25 mm, or from 10 to 20 mm. To further reduce weight using the reinforced alloy, the cross-sectional diameter may be narrower without sacrificing theft deterrence. The legs may be spaced apart at a sufficient distance for securing the vehicle to an object.

As described herein the bracket is constructed of a novel lightweight material that has high strength while preferably being demonstrating resistance to cutting. Although the weight of the lock may vary depending on the application and size, including the type of locking mechanism, the embodiments described herein provide a lightweight bracket. The bracket made from the novel lightweight material described herein can provide significant weight reduction when compared with similarly sized steel bracket. This allows a weight reduction of at least 25% over a comparable steel bracket, e.g., more preferably at least 30% or most preferably at least 35%. Accordingly, the embodiments described herein may allow for a bracket that weighs less than or equal to 2 kg, e.g., less than 1.7 kg, less than 1.5 kg, less than 1.3 kg, less than 1.1 kg or less than 1 kg.

In another embodiment, the lock may comprise two or more straight brackets, two crossbars, and a locking mechanism. When the straight brackets are inserted and locked into the crossbars the lock is similar in shape to a U-lock and may be referred to as a square lock. The two straight brackets may be separate from one another. Each of the two straight brackets may have legs or fittings with configured feet. The feet may be configured to fit into holes in each of the removable crossbars. Each of the removable crossbars may comprise a straight crossbar with openings to receive the feet. Each crossbar may include a locking mechanism to retain or release the feet.

In yet another embodiment, the lock may comprise a plurality of brackets that are assembled in a foldable configuration when not in use. In such embodiments, the brackets may have a square or rectangular cross-sectional shape and are in the form of bars. When unfolded, the brackets may have a similar shape to a U-lock. Without limitation on the brackets, the plurality of brackets in such configurations may comprise connectors, bolts/nuts, screws, rivets, etc., and a locking mechanism.

One or more of the components of the lock, such as the brackets and/or crossbars, may be constructed of a reinforced alloy comprising aluminum or an aluminum alloy having fine reinforcement particles dispersed therein and coarse reinforcement particles, as described further below. In one embodiment, the bracket has a solid configuration with the reinforced alloy. In other embodiments, the bracket may have an inner core comprising the reinforced alloy, with an outer material surrounding the reinforced alloy. When further weight reduction is desirable the bracket may have a hollow cross-section, similar to a tube, that is made of the reinforced alloy. In addition, the reinforced alloy often is at least partially covered with a thermoplastic material such as a polyolefin, polyester or polyurethane. This covering provide aesthetic appearance to the user and provided protection against scratches or dings.

For purposes of the present disclosure, the locking mechanism is not particularly limited and may be any suitable locking mechanism. Accordingly and without limitation, the locking mechanism may be electromechanical or mechanical, for example. In one embodiment, the locking mechanism may be an electromechanical locking device arranged in a lock body. The locking device may comprises an electric motor, a rotating latch in the form of a cam driven by the electric motor, and two blocking elements. In a locked position, the blocking elements are urged radially outwardly into engagement recesses of a closing hoop, thereby locking the closing hoop in a closed position by forming a closed loop. In a release position of the rotating latch, the blocking elements are released for a radially inward moving back so that the closing hoop may be moved from the closed position shown into an open position. One or more components of the locking device, such as the blocking elements and/or the closing hoop, may comprise an aluminum alloy as described further below.

In an embodiment, the locking mechanism may be a mechanical lock, such as a rotatable lock. The lock may be operated with a key. The lock may operate an arcuate cam which is rotated from an open to a locked position by means of the key.

The present disclosure provides a reinforced alloy comprising including fine reinforcement particulates dispersed in aluminum or an aluminum alloy. As described further below, the reinforced alloys of the present disclosure may provide improved resistance to cutting. Specifically, the reinforced alloys of the present disclosure provide a significant improvement in resistance to cutting by angle grinders, which is becoming increasingly common.

In one embodiment, an aluminum alloy is particular suitable to use a material for a bracket. The type of aluminum alloy may include aluminum as a major component and at least one alloying element selected from the group consisting of chromium, copper, lithium, magnesium, manganese, zinc, iron, nickel, silver, scandium, vanadium, titanium and silicon.

Aluminum as the major component may be present in an amount of greater than or equal to 70 wt. %; e.g., greater than or equal to 75 wt. %, greater than or equal to 80 wt. %, greater than or equal to 85 wt. %, greater than or equal to 90 wt. %, or greater than or equal to 95 wt. %. In some embodiments the aluminum is present in essentially pure commercial form, and is greater than or equal to 99 wt. %. Suitable ranges for the aluminum content may range from 70 wt. % to 99.9 wt. %, e.g., from 70 wt. % to 99 wt. %, from 75 wt. % to 98.5 wt. %, from 75 wt. % to 98 wt. %, from 80 wt. % to 96 wt. %, from 85 wt. % to 95 wt. %, from 88 wt. % to 94 wt. %, or from 90 wt. % to 94 wt. %.

In one embodiment, the aluminum alloy is alloyed with one or more of the following alloy metals chromium, copper, lithium, magnesium, manganese, zinc, iron, nickel, silver, scandium, vanadium, titanium, silicon, and combinations thereof. In particular, copper, magnesium, manganese, titanium, and combinations thereof are particularly suited for aluminum alloys. In some embodiments, a minor amount of oxygen, e.g. less than 0.9 wt. %, may be present in the aluminum alloy. The aluminum alloy may comprise from 70 wt. % to 99.9 wt. % of aluminum, from 0 to 10 wt. % chromium, from 0 to 10 wt. % copper, from 0 to 3 wt. % lithium, from 0 to 5 wt. % magnesium, from 0 to 3 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 3 wt. % iron; and/or from 0 to 25 wt. % silicon. Preferred amounts for one or more of the alloying metals are described further herein for suitable metals.

The loading of the chromium as an alloy metal may be from 0 to 10 wt. %, e.g., from 0 to 6 wt. %, from 0.1 to 5 wt. %, from 0.5 to 4.5 wt. %, or from 0.5 to 4 wt. %.

The loading of the copper as an alloy metal may be from 0 to 10 wt. %, e.g., from 0 to 6 wt. %, from 0.1 to 5 wt. %, from 0.5 to 4.5 wt. %, or from 0.5 to 4 wt. %. The aluminum alloy may comprise from 70 wt. % to 99.9 wt. % of aluminum, from 0 to 10 wt. % chromium, from 0.1 to 5 wt. % copper, from 0 to 3 wt. % lithium, from 0 to 5 wt. % magnesium, from 0 to 3 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 3 wt. % iron; and/or from 0 to 25 wt. % silicon.

The loading of the lithium as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %.

The loading of the magnesium as an alloy metal may be from 0 to 5 wt. %, e.g., from 0 to 4.5 wt. %, from 0 to 3.0 wt. %, from 0.1 to 2.5 wt. %, from 0.2 to 2.0 wt. %, or from 0.3 to 1.8 wt. %. In one preferred embodiment, the magnesium as an alloy metal may be from 2.5 to 5.0 wt. %, e.g., from 2.6 to 4.9 wt. %, from 3.0 to 4.5 wt. %. or from 3.5 to 4.5 wt. %.

The loading of the manganese as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %. When a combination of manganese and magnesium are used as alloy metals, the total loading of the combination may be less than or equal to 5 wt. %, e.g., less than 4.5 wt. % or less than 4 wt. %. The aluminum alloy may comprise from 70 wt. % to 99.9 wt. % of aluminum, from 0 to 10 wt. % chromium, from 0 to 10 wt. % copper, from 0 to 3 wt. % lithium, 0.1 to 2.5 wt. % magnesium, 0.1 to 2.5 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 3 wt. % iron; and/or from 0 to 25 wt. % silicon.

The loading of the zinc as an alloy metal may be from 0 to 5.5 wt. %, e.g., from 0.1 to 5.5 wt. %, from 0.1 to 3.5 wt. %, from 0.1 to 3.0 wt. %, from 0 to 2.5 wt. %, from 0.1 to 2.5 wt. %, from 0.2 to 2.0 wt. %, or from 0.3 to 1.8 wt. %. The aluminum alloy may comprise from 70 wt. % to 99.9 wt. % of aluminum, from 0 to 10 wt. % chromium, from 0 to 10 wt. % copper, from 0 to 3 wt. % lithium, from 0 to 5 wt. % magnesium, from 0 to 3 wt. % manganese, from 0.1 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 3 wt. % iron; and/or from 0 to 25 wt. % silicon.

The loading of the nickel as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %.

The loading of the silver as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %.

The loading of the scandium as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %.

The loading of the vanadium as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %.

The loading of the titanium as an alloy metal may be from 0 to 1.0 wt. %, e.g., from 0.001 to 1.0 wt. %, from 0.005 to 0.75 wt. %, from 0.005 to 0.1 wt. %, or from 0.01 to 0.06 wt. %.

The loading of the iron as an alloy metal may be from 0 to 3 wt. %, e.g., from 0 to 2.5 wt. %, from 0.1 to 2.5 wt. %, from 0.2 to 2.0 wt. %, or from 0.3 to 1.8 wt. %. The aluminum alloy may comprise from 70 wt. % to 99.9 wt. % of aluminum, from 0 to 10 wt. % chromium, from 0 to 10 wt. % copper, from 0 to 3 wt. % lithium, from 0 to 5 wt. % magnesium, from 0 to 3 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0.1 to 2.5 wt. % iron; and/or from 0 to 25 wt. % silicon.

The loading of the silicon as an alloy metal may be from 0 to 25 wt. %, e.g., from 0 to 20 wt. %, from 0.1 to 20 wt. %, from 0.1 to 5.0 wt. %, or from 0.25 to 1.0 wt. %. In other embodiments, the silicon loading may be less than or equal to 0.5 wt. %, e.g., less than 0.4 wt. %, less than 0.3 wt. % or less than 0.25 wt. %. In one embodiment, the aluminum alloy may comprise from 70 wt. % to 99.9 wt. % of aluminum, from 0 to 10 wt. % chromium, from 0 to 10 wt. % copper, from 0 to 3 wt. % lithium, from 0 to 5 wt. % magnesium, from 0 to 3 wt. % manganese, from 0 to 5.5 wt. % zinc, from 0 to 3 wt. % nickel, from 0 to 3 wt. % silver, from 0 to 3 wt. % scandium, from 0 to 3 wt. % vanadium, from 0 to 1.0 wt. % titanium, from 0 to 1.0 wt. % titanium, from 0 to 3 wt. % iron, and/or from 0.1 to 20 wt. % silicon.

Various aluminum alloys may be used with the first reinforcement particles and second reinforcement particles as described herein. Non-limiting examples of suitable aluminum alloys include 2009, 2124, 2090, 2099, 6061, and 6082, for example. When low and medium strength 2xxx and 6xxx aluminum alloys are utilized, their strengths can be increased to levels equivalent to or greater than 7xxx aluminum alloys by heat treatment, for example.

In some embodiments, the aluminum alloy comprises from about 91.2 wt. % to about 98.6 wt. % aluminum, from about 0.15 wt. % to about 4.9 wt. % copper, from about 0.1 wt. % to about 1.8 wt. % magnesium, and from about 0.1 wt. % to about 1 wt. % manganese.

In some embodiments, the aluminum alloy contains from about 91.2 wt. % to about 98.6 wt. % aluminum, from 0 wt. % to about 4.4 wt. % copper, from 0.8 wt. % to about 1.8 wt. % magnesium, from 0 wt. % to about 0.9 wt. % manganese, from 0 wt. % to about 0.2 wt. % iron, from 0 wt. % to about 0.6 wt. % oxygen, from 0 wt. % to about 0.8 wt. % silicon, and from 0 wt. % to about 0.25 wt. % zinc.

In some embodiments, the aluminum alloy may include from about 91.2 wt. % to about 94.7 wt. % aluminum, from about 3.8 wt. % to about 4.9 wt. % copper, from about 1.2 wt. % to about 1.8 wt. % magnesium, and from about 0.3 wt. % to about 0.9 wt. % manganese.

In some embodiments, the aluminum alloy contains from about 92.8 wt. % to about 95.8 wt. % aluminum, from about 3.2 wt. % to about 4.4 wt. % copper, from 0 wt. % to about 0.2 wt. % iron, from about 1.0 wt. % to about 1.6 wt. % magnesium, from 0 wt. % to about 0.6 wt. % oxygen, from 0 wt. % to about 0.25 wt. % silicon, and from 0 wt. % to about 0.25 wt. % zinc.

In some embodiments, the aluminum alloy contains from about 90 wt. % to about 97.5 wt. % aluminum, from 0 to 6 wt. % copper, from 0 to 2.5 wt. % iron, from about 3.5 wt. % to about 4.5 wt. % magnesium, from about 0.3 wt. % to about 0.9 wt. % manganese, from 0 to 6 wt. % chromium, from 0 wt. % to about 0.6 wt. % oxygen, from 0 to 20 wt. % silicon, from 0 to 1.0 wt. % titanium, and from 0 wt. % to about 0.25 wt. % zinc.

In some embodiments, the aluminum alloy contains from about 90 wt. % to about 97.5 wt. % aluminum, from 0.1 to 5.5 wt. % zinc, from 0 to 2.5 wt. % iron, from 0.1 to 2.5 wt. % magnesium, from 0.1 to 2.5 wt. % manganese, from 0 to 6 wt. % chromium, from 0 wt. % to about 0.6 wt. % oxygen, from 0 to 20 wt. % silicon, from 0 to 6 wt. % copper, and from 0 to 1.0 wt. % titanium.

The reinforced alloys described herein comprise fine (first) reinforcement particles. These particles do not form alloys with the aluminum or aluminum alloy and are discretely dispersed through the aluminum or aluminum alloy to form a composite. Suitable fine reinforcement particles may include at least one ceramic material selected from carbides, oxides, silicides, borides, and nitrides. The fine reinforcement particles may include at least one ceramic material selected from silicon carbide, silicon nitride, silicon dioxide, titanium carbide, titanium nitride, titanium boride, boron carbide, aluminum oxide, and zirconium oxide. In a preferred embodiment, the fine reinforcement particles may include at least one ceramic material selected from silicon carbide, aluminum oxide, or titanium boride.

The fine (first) reinforcement particles may have an average particle size (D50) of from 0.1 μm to 5.0 μm, such as 0.1 μm to 4.5 μm, 0.1 μm to 4.0 μm, 0.1 μm to 3.0 μm, 0.5 μm to 3.0 μm, 0.7 μm to 3.0 μm, 0.5 μm to 2.0 μm, 1.0 μm to 2.5 μm, or any value or range encompassing these endpoints.

The composite of the aluminum alloy and fine reinforcement particles may contain from 60 wt. % to 95 wt. % of the aluminum alloy and from 5 wt. % to 40 wt. % of the fine reinforcement particles, based on the weight of the composite. Above 40 wt. % of the fine reinforcement particles the properties of the aluminum deteriorate. In one embodiment, the composite comprises from 60 wt. % to 95 wt. % of the aluminum alloy, e.g., 70 wt. % to 93 wt. % of the aluminum alloy, 75 wt. % to 92 wt. % of the aluminum alloy, 76 wt. % to 90 wt. % of the aluminum alloy, 78 wt. % to 88 wt. % of the aluminum alloy or 80 wt. % to 86 wt. % of the aluminum alloy, based on the weight of the composite. Accordingly, the fine reinforcement particles may be present in the composite in an amount from 5 wt. % to 40 wt. %, e.g., from 7 wt. % to 35 wt. %, from 10 wt. % to 30 wt. %, from 13 wt. % to 25 wt. %, or from 15 wt. % to 20 wt. %, based on the weight of the composite.

To form the reinforced alloy, additional coarse (second) reinforcement particles is advantageously used. This forms a reinforced alloy that is effective at deferring theft, resistance against tools, and achieves a desired weight reduction. Similar to the fine reinforcement particles, the coarse reinforcement particles may include at least one ceramic material selected from carbides, oxides, silicides, borides, and nitrides. The coarse reinforcement particles may include at least one ceramic material selected from silicon carbide, silicon nitride, silicon dioxide, titanium carbide, titanium nitride, titanium boride, boron carbide, aluminum oxide, and zirconium oxide. In a preferred embodiment, the coarse reinforcement particles may include at least one ceramic material selected from silicon carbide, aluminum oxide, or titanium boride. In one embodiment, the fine and coarse reinforcement particles are a similar ceramic material. In another embodiment, at least 50% of the fine and coarse reinforcement particles are a similar ceramic material.

The coarse reinforcement particles have a sufficient size to provide the reinforced alloy with improved resistance to cutting with a saw or grinder. The coarse reinforcement particles are larger than the fine reinforcement particles. In one embodiment, the coarse reinforcement particles are at least 5×larger than the fine reinforcement particles, e.g., at least 10×larger than the fine reinforcement particles or even at least 20×. The coarse reinforcement particles are preferably solid particles and not an agglomeration of finer particles. In one embodiment, the coarse reinforcement particles may have an average particle size (D50) being greater than or equal to 20 μm, e.g., 25 μm or greater, 30 μm or greater, 50 μm or greater, 100 μm or greater, 150 μm or greater, or 200 μm or greater for example. In terms of ranges, the coarse reinforcement particles may be from 20 μm to 200 μm, e.g, from 20 μm to 150 μm, from 25 μm to 150 μm, from 50 μm to 125 μm, from 75 μm to 125 μm, from 90 μm to 115 μm, or from 95 μm to 105 μm.

The second reinforcement particles may be present in the reinforced alloy in an amount of 1 wt. % to 10 wt. %, based on the weight of the reinforced alloy, e.g., 2 wt. % to 8 wt. %, 3 wt. % to 7 wt. %, 4 wt. % to 6 wt. %. When the loading is too high the mechanical properties and processing of the reinforced alloy deteriorate. Accordingly, the reinforced alloy comprises the composite of the aluminum alloy and fine reinforcement particles may contain from 60 wt. % to 95 wt. % of the aluminum alloy and from 5 wt. % to 40 wt. % of the fine reinforcement particles, and from 1 wt. % to 10 wt. % of the fine reinforcement particles, based on the weight of the reinforced alloy.

The addition of the reinforcement particles may provide advantages in the cutting resistance, such as cutting with a hand saw or an angle grinder. Additionally, the aluminum materials of the present disclosure may provide a significant weight reduction in comparison to the hardened steel alloy products currently available. In one embodiment, there is at least a 25% weight reduction over conventional hardened steel alloy products, e.g. at least a 30% weight reduction, at least a 35% weight reduction, at least a 40% weight reduction, or at least a 45% weight reduction.

The present disclosure further provides methods of making a reinforced alloy composite. The methods comprise using high energy mixing to combine (i) particles of an aluminum or aluminum alloy with (ii) reinforcement particles having an average particle size (D50) of from 0.1 μm to 5 μm and (iii) reinforcement particles having an average particle size (D50) of 20 μm to 200 μm to provide a first mixture. The mixture may then be processed to achieve an even distribution of the reinforcement particles in a second mixture. The second mixture may then be subjected to microcompacting to produce a billet. The billet may then be used to produce a final article containing the reinforced alloy composite.

The final article may be produced by extruding the reinforced alloy composite, bending into the desired shape and machining as necessary.

The following examples are provided to illustrate the alloys, processes, articles, and properties of the present disclosure. The examples are merely illustrative and are not intended to limit the disclosure to the materials, conditions, or process parameters set forth therein.

### Example

Five 13×15 mm extruded bars were tested for resistance to cutting in two different test, saw blade and angle grinder. The bars were subjected to cutting tests using a saw blade according to the VdS testing standard, 2597: 2021-05 (03). The cutting test using an angle grinder does not currently have a testing standard, but the industry expects a testing standard in the near future. Table 1 provides the information for the test bars:

TABLE 1

| | | Fine Reinforcement | | | Coarse Reinforcement | | |
|---|---|---|---|---|---|---|---|
| | | | d(50) | | | d(50) | |
| Bar | Alloy | Type | microns | wt. % | Type | microns | wt. % |
| 1 | Al 2124 | SiC | 0.7 | 25% | None | | |
| | | | microns | | | | |
| 2 | Al 2124 | SiC | 3 | 25% | None | | |
| | | | microns | | | | |
| 3 | Al 2009 | SiC | 4.5 | 15% | None | | |
| | | | microns | | | | |
| 4 | Al 2124 | SiC | 0.7 | 17% | SiC | 22 | 5% |
| | | | microns | | | | |
| 5 | Al 2124 | SiC | 0.7 | 17% | SiC | 100 | 5% |
| | | | microns | | | | |
| 6 | Hardened | None | | | None | | |
| | Steel | | | | | | |

Bars 1 and 2 comprised an aluminum alloy, namely Al 2124 (Al 93.5%; Cu 4.4%; Mg 1.5%; Mn 0.6%), with fine silicon carbide (SiC) reinforcing particles having an average particle size of 0.7 microns or 3 microns. Bar 3 comprised an aluminum alloy, Al 2009, with fine SiC particles having an average (d50) particle size of 4.5 microns. A fourth bar comprised an aluminum alloy (Al 2124) including a coarse SiC reinforcing particle in an amount of 5 wt. %, with an average particle diameter of 22 um. A fifth bar comprised an aluminum alloy (Al 2124) including a coarse SiC reinforcing particle in an amount of 5 wt. %, with an average particle diameter of 100 um. A sixth bar was prepared as a comparative example comprising hardened steel with any of the reinforcement particles.

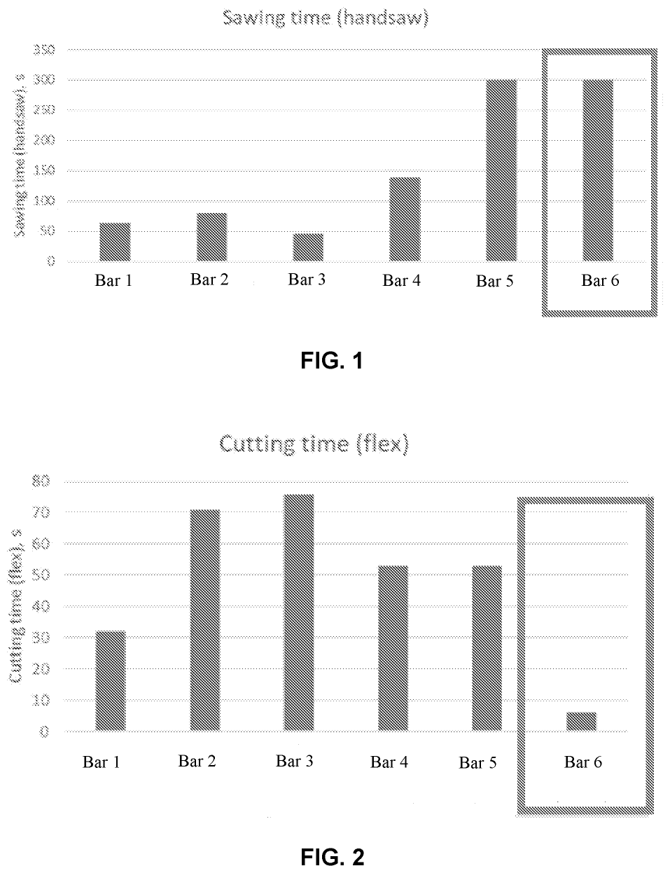

The bars were subjected to cutting tests using a saw blade according to the VdS testing standard, 2597: 2021-05 (03). As shown in FIG. 1, the saw time for Bar 5 match the comparative example 6 and after 5 minutes (300 seconds) the tests were suspended after the saw blade wore out. The saw time for bars 1-4 exceed 45 seconds, which is sufficient time to defer theft in public areas. Further improvements in cut time were also shown with bar 4.

Next, the bars were subjected to cutting tests using an angle grinder (flex cutting). As shown in FIG. 2, the aluminum alloy bars (Bars 1-5) significantly outperformed the comparative example comprising hardened steel. The comparative example had no wear of the cutting disc and the cutting time was very fast. In contrast, Bars 1-5 had significantly longer times to resist cutting by an angle grinder.

The combination of acceptable cutting resistance to the saw blade and angle grinder demonstrate the ability of the lightweight materials described herein as shown in Bars 1-5 are capable of deterring theft.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A lock for a vehicle having an opening, the lock comprising:
a bracket capable of fitting through the opening, and
a crossbar to removable secure at least a portion of the bracket thereby lock the vehicle to an object,
wherein the bracket comprises a reinforced alloy comprising:
(i) a composite comprising:
(a) an aluminum or aluminum alloy; and
(b) first reinforcement particles dispersed in the aluminum or aluminum alloy, the first reinforcement particles having an average particle size (D50) of from 0.1 μm to 5.0 μm; and
(ii) second reinforcement particles having an average particle size (D50) being greater than or equal to 20 μm.

2. The lock of claim 1, wherein the bracket has a U-shape with two substantially parallel legs.

3. The lock of claim 2, wherein each of the two substantially parallel legs have a solid cross-section.

4. The lock of claim 1, wherein the vehicle is a bicycle, motorcycle, moped or scooter.

5. The lock of claim 1, wherein the crossbar comprises a locking mechanism.

6. The lock of claim 1, wherein the aluminum alloy comprises aluminum; and at least one alloying element selected from the group consisting of chromium, copper, lithium, magnesium, manganese, zinc, iron, nickel, silver, scandium, vanadium, titanium, and silicon.

7. The lock of claim 1, wherein the aluminum alloy comprises:
from 70 wt. % to 99.9 wt. % of aluminum;
from 0 to 10 wt. % chromium;
from 0 to 10 wt. % copper;
from 0 to 3 wt. % lithium;
from 0 to 5 wt. % magnesium;
from 0 to 3 wt. % manganese;
from 0 to 5.5 wt. % zinc;
from 0 to 3 wt. % nickel;
from 0 to 3 wt. % silver;
from 0 to 3 wt. % scandium;
from 0 to 3 wt. % vanadium;
from 0 to 1.0 wt. % titanium;
from 0 to 3 wt. % iron; and/or
from 0 to 25 wt. % silicon.

8. The lock of claim 1, wherein the first reinforcement particles are selected from the group comprising silicon carbide, titanium carbide, boron carbide, silicon nitride, titanium nitride, and zirconium oxide.

9. The lock of claim 1, wherein the second reinforcement particles are selected from the group comprising silicon carbide, titanium carbide, boron carbide, silicon nitride, titanium nitride, and zirconium oxide.

10. The lock of claim 1, wherein the first reinforcement particles comprise silicon carbide.

11. The lock of claim 1, wherein the second reinforcement particles comprise silicon carbide.

12. The lock of claim 1, wherein the first reinforcement particles have an average particle size (D50) of from 0.7 μm to 3.0 μm.

13. The lock of claim 1, wherein the second reinforcement particles have an average particle size (D50) from 20 μm to 200 μm.

14. The lock of claim 1, wherein the second reinforcement particles are at least 5×larger than the first reinforcement particles.

15. The lock of claim 1, wherein the composite comprises the aluminum or aluminum alloy in an amount from 60 wt. % to 95 wt. %, based on the weight of the composite.

16. The lock of claim 1, wherein the composite comprises the first reinforcement particles in an amount from 5 wt. % to 40 wt. %, based on the weight of the composite.

17. The lock of claim 1, wherein the reinforced alloy comprises the second reinforcement particles in an amount from 1 wt. % to 10 wt. %, based on the weight of the reinforced alloy.

18. A lock for a vehicle having an opening, the lock comprising:
a bracket capable of fitting through the opening, and
a crossbar to removable secure at least a portion of the bracket thereby lock the vehicle to an object,
wherein the bracket is formed from a reinforced alloy comprising an aluminum or aluminum alloy and first reinforcement particles dispersed in the aluminum or aluminum alloy, the first reinforcement particles having an average particle size (D50) of from 0.1 μm to 5.0 μm.

19. The lock of claim 18, wherein the first reinforcement particles are selected from the group comprising silicon carbide, titanium carbide, boron carbide, silicon nitride, titanium nitride, and zirconium oxide.

20. The lock of claim 18, wherein the first reinforcement particles having an average particle size (D50) of from 0.7 μm to 3.0 μm.
